(19) United States
(12) Patent Application Publication
(10) Pub. No.: US 2017/0208507 A1
(43) Pub. Date: Jul. 20, 2017

(54) Methods and Apparatuses for Performing a Handover in a High-Speed Traffic Environment

(71) Applicant: Telefonaktiebolaget LM Ericsson (publ), Stockholm (SE)

(72) Inventors: Hai WANG, Beijing (CN); Rui FAN, Beijing (CN); Qingyu MIAO, BEIJING (CN)

(21) Appl. No.: 15/320,515

(22) PCT Filed: Aug. 14, 2014
(86) PCT No.: PCT/CN2014/084425

§ 371 Date: Dec. 20, 2016

(51) Int. Cl. H04W 36/00; H04W 24/10; H04W 36/30; H04W 36/22

(52) U.S. Cl. CPC H04W 36/0005; H04W 36/22; H04W 24/10; H04W 36/30; H04W 84/005

(57) ABSTRACT

Methods and apparatuses for performing a group handover in a high-speed traffic environment are provided. The method comprises receiving a measurement report from at least one terminal device in the high-speed traffic environment. The method also comprises determining whether the at least one terminal device is a member of a group based on group information indicating, as members of the group, a plurality of terminal devices. The method further comprises transmitting, upon determining that the at least one terminal device is the member of the group, a plurality of handover requests each of which corresponds to one terminal device in the group to a target network node for the handover of each terminal device in the group to the target network node. With the methods and apparatuses, the handover successful rate in the high-speed traffic environment may be improved and signaling overhead arising from the handover could be decreased.

### TECHNICAL FIELD

The non-limiting and exemplary embodiments of the present disclosure herein relate to a wireless communication field. In particular, the embodiments herein relate to methods and apparatuses for performing a handover in a high-speed traffic environment.

### BACKGROUND

With rapid transit systems, such as high-speed trains/railways or bus systems, are widely deployed, more and more passengers take high-speed vehicles to travel. When sitting in the high-speed train or bus, the passengers may desire to have access to wireless services. Thus, the wireless service operators are now taking efforts to provide good communication services to such passengers. To this end, dedicated third Generation Partnership Project (“3GPP”) Long Term Evolution (“LTE”) networks are set up along the railways so as to provide wireless service coverage. Due to high penetration loss through the carriage, site-to-site distances of neighboring evolved Node Bs (“eNBs”) should not be too long such that the power received by user equipment (“UEs”) within the carriage may be maintained at a reasonable level.

For example, assume that a recommended site-to-site distance is 1 km and the speed of a high-speed train is 300 km/h, a handover procedure involving handing UEs from a source eNB over to a target eNB may occur every 12 seconds. Further, assume that 100 passengers are in one carriage and the high-speed train consists of 10 carriages, then the total number of passengers in the high-speed train is 1000. If 80% of the total number of the passengers would use their UEs, such as smart phones, for wireless service, this may engender a challenge to guarantee both high user throughput and handover successful rates for 800 passengers.

As is known in the art, a handover procedure generally includes several signaling transmission among the involved UE, the source eNB and the target eNB, and it may take hundreds of milliseconds for the UE to complete the handover procedure. During this time period, the high-speed train, as exampled above, moves very quickly from the source eNB to the target eNB, which means that the radio link quality for the UE in the source cell deteriorates sharply. In order to make a successful handover, the source eNB must schedule the UE in time such that handover related signaling may be transmitted and received in a timely fashion; otherwise, a handover failure is very likely to occur due to a Radio Link Failure (“RLF”) in the source eNB. This problem becomes even more severe when many UEs are experiencing handovers at the same time in a short time window, leading to a huge amount of signaling between UEs and the involved eNBs.

Different solutions have been proposed to mitigate the handover issues, e.g., reducing the value of the parameter “Time to Trigger” so that the handover event could be triggered earlier or combining several cells into one cell so that the number of handover events is reduced. However, these solutions are insufficient in term of reducing handover signaling.

### SUMMARY

It is an object of the present disclosure to address at least one of the problems outlined above, and to provide efficient mechanisms for a group handover in the high-speed traffic environment.

According to an aspect of the disclosure, there is provided a method for performing a handover in a high-speed traffic environment in a source network node. The method comprises receiving a measurement report from at least one terminal device in the high-speed traffic environment. The method also comprises determining whether the at least one terminal device is a member of a group based on group information indicating, as members of the group, a plurality of terminal devices. The method further comprises transmitting, upon determining that the at least one terminal device is the member of the group, a plurality of handover requests each of which corresponds to one terminal device in the group to a target network node for the handover of each terminal device in the group to the target network node.

In one embodiment, the method further comprises determining the group information by the source network node based on one or more metrics.

In another embodiment, the method further comprises receiving the group information from another network node that determines the group information based on one or more metrics.

In one embodiment, the one or more metrics include one or more of the following: downlink signal quality reported from the plurality of terminal devices; uplink signal quality determined by the source network node or the other network node with respect to the plurality of terminal devices; Doppler frequency estimates made by the source network node or the other network node with respect to the plurality of terminal devices; and handover history recorded by the source network node or the other network node with respect to the plurality of terminal devices.

In an additional embodiment, the group information is determined or received on a periodic or event-triggered basis.

In a further embodiment, the method further comprises receiving a plurality of handover acknowledgement messages from the target network node and transmitting a handover command to each terminal device in the group via one signaling message.

In one embodiment, the method further comprises transmitting the determined or received group information to other network nodes.

According to another aspect of the disclosure, there is provided a method for performing a handover in a high-speed traffic environment in a terminal device. The method comprises receiving, as a member of a group, a handover command transmitted from a source network node for the handover of the terminal device to a target network node, wherein the group includes a plurality of terminal devices and the handover command is transmitted in response to a measurement report transmitted by another member of the group to the source network node. The method further comprises transmitting, based on the handover command, a random access request to the target network node for connecting to the target network node.

According to an aspect of the disclosure, there is provided a source network node for performing a handover in a high-speed traffic environment. The source network node comprises a receiver configured to receive a measurement report from at least one terminal device in the high-speed traffic environment. The source network node also comprises a determiner configured to determine whether the at least one terminal device is a member of a group based on group information indicating, as members of the group, a plurality of terminal devices. The source network node further comprises a transmitter configured to transmit, upon determining that the at least one terminal device is the member of the group, a plurality of handover requests each of which corresponds to one terminal device in the group to a target network node for the handover of each terminal device in the group to the target network node.

According to another aspect of the disclosure, there is provided a terminal device for performing a handover in a high-speed traffic environment. The terminal device comprises a receiver configured to receive, as a member of a group, a handover command transmitted from a source network node for the handover of the terminal device to a target network node, wherein the group includes a plurality of terminal devices and the handover command is transmitted in response to a measurement report transmitted by another member of the group to the source network node. The terminal device further comprises a transmitter configured to transmit, based on the handover command, a random access request to the target network node for connecting to the target network node.

According to an aspect of the disclosure, there is provided a source network node for performing a handover in a high-speed traffic environment. The source network node comprises a processor and a memory, the memory containing instructions executable by the processor, whereby the source network node is operative to receive a measurement report from at least one terminal device in the high-speed traffic environment, determine whether the at least one terminal device is a member of a group based on group information indicating, as members of the group, a plurality of terminal devices and transmit, upon determining that the at least one terminal device is the member of the group, a plurality of handover requests each of which corresponds to one terminal device in the group to a target network node for the handover of each terminal device in the group to the target network node.

According to an aspect of the disclosure, there is provided a source network node for performing a handover in a high-speed traffic environment. The source network node comprises processing means operative to receive a measurement report from at least one terminal device in the high-speed traffic environment, determine whether the at least one terminal device is a member of a group based on group information indicating, as members of the group, a plurality of terminal devices and transmit, upon determining that the at least one terminal device is the member of the group, a plurality of handover requests each of which corresponds to one terminal device in the group to a target network node for the handover of each terminal device in the group to the target network node.

According to an aspect of the disclosure, there is provided a terminal device for performing a handover in a high-speed traffic environment. The terminal device a processor and a memory, the memory containing instructions executable by the processor, whereby the terminal device is operative to receive, as a member of a group, a handover command transmitted from a source network node for the handover of the terminal device to a target network node, wherein the group includes a plurality of terminal devices and the handover command is transmitted in response to a measurement report transmitted by another member of the group to the source network node and transmit, based on the handover command, a random access request to the target network node for connecting to the target network node.

According to another aspect of the disclosure, there is provided a terminal device for performing a handover in a high-speed traffic environment. The terminal device comprises processing means operative to receive, as a member of a group, a handover command transmitted from a source network node for the handover of the terminal device to a target network node, wherein the group includes a plurality of terminal devices and the handover command is transmitted in response to a measurement report transmitted by another member of the group to the source network node and transmit, based on the handover command, a random access request to the target network node for connecting to the target network node.

By means of solutions discussed in the various aspects and embodiments as mentioned above, the handover procedures for the terminal devices in the group in the high-speed traffic environment may be simplified since the handover is performed on a group-by-group basis (i.e., a group handover), thereby decreasing the signaling cost in association with the handover in the high-speed traffic environment. Further, since the group handover is triggered by a member of the group of the terminal devices, it is unnecessary for other terminal devices to transmit the measurement reports to the source network node. Therefore, the radio resources saved from the less measurement report could be used for data traffic, thereby giving the user throughput a boost. For example, the uplink data resource and the downlink control resources allocated to the handover signaling could be saved.

In addition, by determining or identifying a plurality of terminal devices as a group based on one or more metrics, the feasibility and accuracy of the group handover may be improved. Furthermore, due to the group handover, the terminal devices may be handed over to the target network node in due course and thereby the handover failure could be alleviated and the handover successful rate could be increased.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic overview depicting a wireless communication network in a high-speed traffic environment, in which example embodiments of the present disclosure may be practiced;

FIG. 2 is a flowchart of a method for performing a handover in a high-speed traffic environment according to an embodiment of the present disclosure;

FIG. 3 is a flowchart of another method for performing a handover in a high-speed traffic environment according to another embodiment of the present disclosure;

FIG. 4 is a messaging diagram schematically illustrating another method for performing a handover in a high-speed traffic environment according to an embodiment of the present disclosure;

FIG. 5 is a block diagram schematically depicting a source network node according to an embodiment of the present disclosure;

FIG. 6 is a block diagram schematically depicting a terminal device according to another embodiment of the present disclosure; and

FIG. 7 is a block diagram schematically depicting a source network node and a terminal device according to an embodiment of the present disclosure.

### DETAILED DESCRIPTION

The present disclosure will now be described more fully hereinafter with reference to the accompanying drawings, in which certain embodiments of the present disclosure are shown. This disclosure may, however, be embodied in many different forms and should not be construed as limited to the embodiments set forth herein; rather, these embodiments are provided by way of example so that this disclosure will, be thorough and complete, and will fully convey the scope of the present disclosure to those skilled in the art. Like numbers refer to like elements throughout the specification.

Generally, all terms used in the claims are to be interpreted according to their ordinary meaning in the technical field, unless explicitly defined otherwise herein. For example, the terminal device in the present disclosure may be any terminal capable of receiving information from and/or transmitting information to the network, connectable to the network wirelessly or via a fixed connection. Examples of the terminal devices may include a personal computer with wireless communication capability, a game console with wireless communication capability, a laptop (a notebook), a personal digital assistant (“PDA”), a mobile station, e.g., a mobile phone such as a smart phone, a communicator, a tablet or a pad. Likewise, the network node, such as a source or target network node, may refer to any suitable radio BS according to any suitable communication standard, such as a Node B (“NB”) or an evolved NB (“eNB”).

All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The discussion above and below in respect of any of the aspects of the present disclosure is also in applicable parts relevant to any other aspect of the present disclosure.

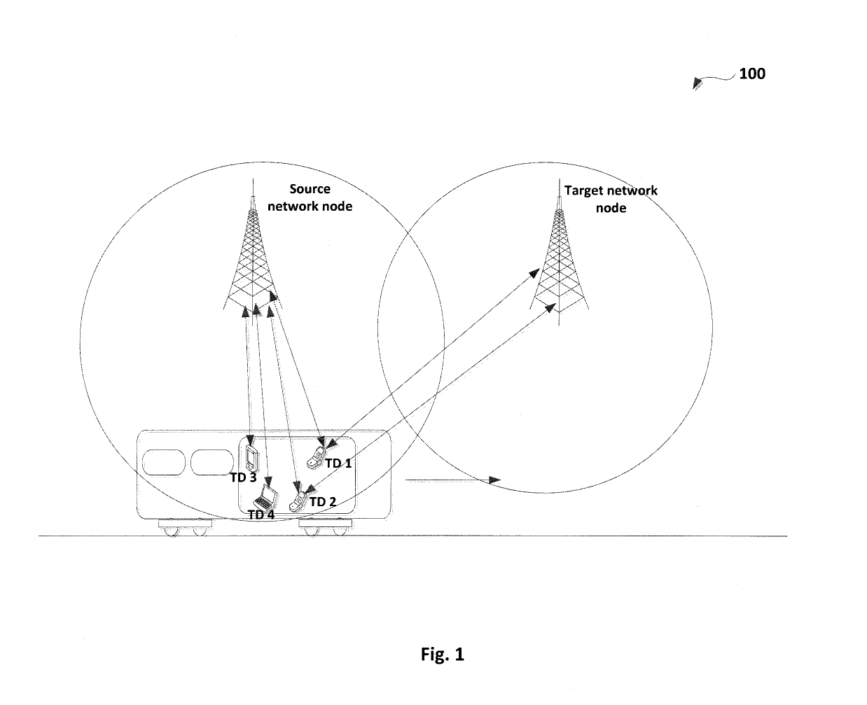

FIG. 1 is a schematic overview depicting a wireless communication network 100 in a high-speed traffic environment, in which example embodiments of the present disclosure may be practiced. As illustrated in FIG. 1, the wireless communication network 100 includes a source network node, for example, a source eNB, and a target network node, for example, a target eNB. Within the coverage area of the source network node depicted by an circle, there are terminal devices (“TD” in short) 1-4 in a carriage of e.g., a high-speed train or bus, which are assumed to connect to the source network node and are about to move in a direction depicted by an arrow to the coverage area of the target network node in a high speed, in which case, a handover procedure directed to each TD may be necessary.

Unlike the conventional handover procedure which may be triggered on a TD-by-TD basis, according to the example embodiments of the present disclosure, the TDs 1-4 may be grouped as a group according to one or more metrics prior to the occurrence of the handover procedure and the handover procedures for all terminal devices in the group may be triggered merely by a measurement report transmitted by one member from the group. In other words, if one TD in the group needs to be handed over to the target network node, other TDs in the group would also be handed over to the target network node regardless of whether they indeed require to be handed over to the target network node or whether they trigger the handover procedure, for example, transmitting the measurement report for the handover.

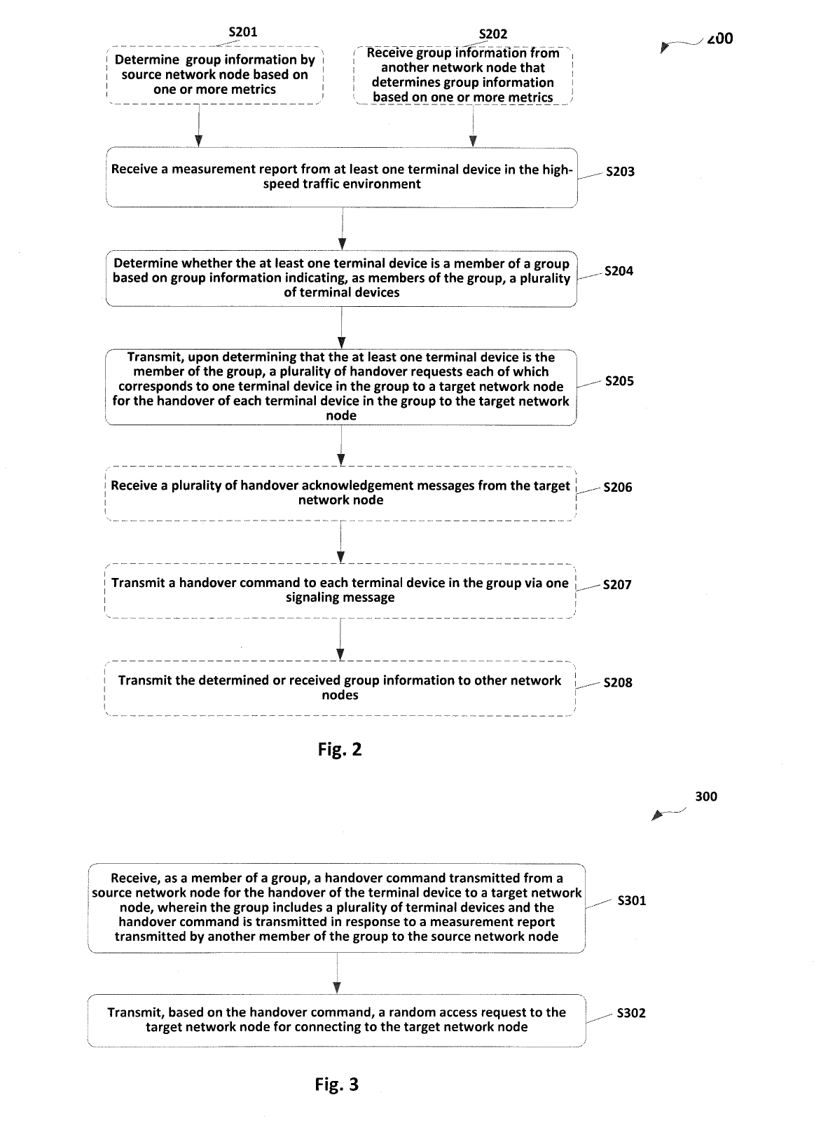

For example, TDs 1-4 as shown are grouped as a group using handover history as a metric, which is related to the TDs 1-4 and recorded by the source network node. When the TD 1 transmits a measurement report triggered by e.g., an A3 event, as is known in the art, to the source network node, the source network node may determine from the group information, which may be collected by itself or received from other network nodes, that the TD 1 is a member of the group insisting of the TDs 1-4 and a group handover directed to the TDs 1-4 should be initiated. Therefore, the source network node may transmit handover requests respectively corresponding to the TDs 1-4 to the target network node and the group consisting of TDs 1-4 may be handed collectively over to the target network node. In this manner, the handover procedure in the high-speed traffic environment could be completed in a timely fashion and the radio resources saved due to a less number of measurement reports could be used for data traffic, thereby improving the user throughput. Hereinafter, the embodiments of the present disclosure will be set forth with reference to FIGS. 2-7, which show more details of the present disclosure.

FIG. 2 is a flowchart of a method 200 for performing a handover in a high-speed traffic environment in a source network node according to an embodiment of the present disclosure. It should be noted that the steps of the method 200 as shown may be carried out by a source network node such as the one illustrated in FIG. 1.

As illustrated in FIG. 2, at step S201, the method 200 determines group information based on one or more metrics collected by the source network node. As an alternative, the method 200 receives group information from another network node that determines group information based on the one or more metrics at step S202. The group information herein may indicate, as members of the group, a plurality of terminal devices. For example, the group information may be implemented as a group identifier to indicates, a plurality of terminal devices, which may meet the following one or more metrics, as a group. In this manner, an association between each terminal device in the group and the group may be established based on the group identifier.

In an example embodiment, the one or more metrics above may include one or more of downlink signal quality reported from the plurality of TDs, uplink signal quality determined by the source network node with respect to the plurality of TDs, Doppler frequency estimates made by the source network node with respect to the plurality of TDs, and handover history recorded by the source network node with respect to the plurality of TDs, as non-limiting examples. The metrics, if necessary, may be measured continuously and filtered appropriately to avoid errors arising during grouping.

The downlink signal quality herein may be characterized or indicated by a Channel Quality Indicator (“CQI”), Channel State Information (“CSI”), Reference Signal Received Quality (“RSRP”) and etc. The uplink signal quality herein may be characterized or indicated by a Signal to Interference plus Noise Ratio (“SINR”). Doppler frequency estimates and the handover history herein may be obtained or recorded by the source network node with respect to each of the plurality of TDs such that the moving directions of each TD may be determined thereon. After collecting the information regarding these metrics, the source network node or another network node may determine which of the plurality of TDs have the similar or same values or characteristics of these metrics.

For example, if some TDs from the plurality of TDs may have the same or closer values of the CQI, CSI, RSRP, SINR, or have the same moving direction, then these TDs should be categorized as a group and should be handed over collectively when a member of the group is about to subject to the handover procedure. Further, it is also possible to set some threshold values with respect to each of these metrics, each threshold value being representative of an acceptable difference between two TDs with respect to each metric. If the difference between TDs with respect to the value of a certain metric is equal to or less than the acceptable difference, then both TDs may be categorized into a same group. As an alternative, it is also possible to set an acceptable value range for each of these metrics and those whose values of these metrics fall within the acceptable value range may be categorized into a same group.

In one example embodiment, the group information may be received or transmitted on a periodic basis or in an event-triggered manner, for example, received upon a request from the source network node or transmitted to other network nodes, for example, upon receipt of requests from other network nodes. Alternatively, the group information may be received or transmitted in association with the handover procedure. In another example embodiment, the group information regarding the grouping relationship among TDs may also be updated either periodically or triggered by certain events by the network for the users active in the network node in the high-speed environment. For example, the network node may periodically identify TDs within one carriage through correlation of one or more of the above-mentioned metrics and categorize them into one group. Also, when one group is handed over from the source network node to the target network node, the target network node may check the validity of such grouping relationship, i.e., in an event-triggered manner.

In one example embodiment, the group information may be transmitted via an X2 interface between the network nodes. In another example embodiment, for a better identification of the TDs in the group, the group identifier, which is common to members of the group, may be set and included in the such group information such that the source network node may determine which group a particular TD belongs to upon receipt of a measurement report transmitted from the particular TD.

Subsequent to step S201 or S202, and over time, the method 200 receives, at the source network node, a measurement report from at least one TD in the high-speed traffic environment, e.g., in the high-speed train or bus, at step S203. The measurement requirements and contents in association with the measurement report herein may be pre-configured by the source network node via a Radio Resource Connection (“RRC”) signaling message, for example, an RRCConnectionReconfiguration message. Upon receipt of the measurement report from the TD, which may be triggered by an A3 or A4 event according to the 3GPP standards, e.g., 3GPP TS 36.331 V9.16.0 (2013 September), in some example embodiments, the method 200, at step S204, determines whether the at least one TD is a member of a group based on the group information indicating, as members of the group, a plurality of TDs.

In one example embodiment, the group information, such as the group identifier, may be transmitted by the source network node to the group before the occurrence of the group handover. In this case, the measurement report transmitted by one member of the group may include the group identifier and the source network node may retrieve previously-stored group information to determine whether the group identifier has been saved before. If the same group identifier as the one included in the measurement report is found in the group information, it may be determined that the at least one TD is a member of the group under the control of the source network node, which may control a number of groups according to its processing capability. In this manner, the source network node may further determine a group handover procedure is needed based on the group identifier and may proceed with the group handover procedure, i.e., handing all TDs in the group, as determined before and possibly indicated by the group information, over to the target network node. If this is not the case, i.e., the TD, which has sent the measurement report to the source network node, does not belong to any previously-determined groups, then the source network node may hand the TD over to the target network node in a conventional manner, as is known to those skilled in the art.

At step S205, the method 200 transmits, upon determining that the at least one TD is the member of the group, a plurality of handover requests each of which corresponds to one TD in the group to the target network node for the handover of each TD in the group to the target network node. In this manner, it is unnecessary to wait for each member of the group to transmit a respective measurement report and therefore, the handover efficiency could be improved and signaling cost may be saved due to this efficient reporting mechanism. In addition, it is to be understood by those skilled that the source network node may transmit, based on the content in the measurement report, to a number of candidate network nodes, if any, the respective handover requests.

After transmitting the handover requests to the target network node, at step 206, the method 200 receives, from the target network node, a plurality of handover acknowledgement messages in which it is specified the acceptance of the handover requests and the number of radio bearers that are supported by the target base station. It is to be understood by those skilled in the art that there may be a plurality of candidate network nodes, each of which may respond to the source network node by transmitting the handover acknowledgment message back to the source network node, and that the source network node may select one of the candidate network nodes as the target network node based on some decision rules or algorithms. For instance, the target network node may be one of the candidate network nodes whose handover acknowledgement message is first received or whose handover acknowledgement message indicates that the radio resources as requested by the TD may be fulfilled.

After that, at step S207, the method 200, upon receipt of the handover acknowledgment message, transmits a handover command to each TD in the group via one signaling message. In this manner, the signaling overhead regarding transmission of the handover command for each TD in the group could be decreased. In contrast, as an alternative, the source network node may transmit the handover command to each TD in the group separately such that each TD in the group may individually receive the handover command intended for it. As is known to those skilled in the art, when receiving the handover command from the source network node, the TD may attempt to initiate a random access procedure with the target network node. Having been subject to a successful random access procedure, the TD may connect to the target network node and transmit a handover complete message to the target network node. Thereupon, the target network node may inform the source network node via the X2 interface of the successful handover of the TD to the target network node. Based on this notification, the source network node may release resources and wireless link allocated to the TD, and delete the user information of the TD.

In one example embodiment, the method 200 further comprises transmitting, at step S208, the group information, such as those determined at step S201 or received at step S202, to other network nodes. Such transmission may be triggered upon receipt of the requests from other network nodes, which, as mentioned before, may be eNBs that have been deployed along the high-speed railway or highway. Also, such transmission may be in association with the handover procedure. For example, when the determined or received group information is available, the source network node may transmit it to other network nodes before, during, or after its handover procedures with the terminal devices served. Also, the source network node may transmit the group information to other network nodes once such information is available without any triggering. In this manner, the calculation workload for the other network nodes to determine their own group information may be reduced. Further, the group information transmitted from the source network node may be used as a reference to refine grouping decisions made by the other network nodes, thereby improving the accuracy of the group information.

The foregoing has discussed the method 200 and its multiple variations according to the example embodiments of the present disclosure. It should be noted that the order of the steps as shown are only for illustrative purposes and should not be used to limit the scope of the present disclosure to this specific form. Further, the steps shown are not all essential for the method 200 to perform the group handover in the high-speed traffic environment. For example, due to the technical expressions in steps S203-S205, a person skilled in the art is able to understand that the operations performed in other steps in the method 200 serve to illustrate further specific details of technical implementations centered around the steps S203-S205.

With the method 200 and its multiple variations according to the example embodiments of the present disclosure, the handover procedures for the group of TDs in the high-speed traffic environment may be simplified since the handover is performed on a group-by-group basis, i.e., the group handover, thereby decreasing the signaling cost in association with the handover in the high-speed traffic environment. Further, since the group handover is triggered by one member of the group of the TDs, it is unnecessary for other TDs to transmit the respective measurement reports to the source network node. Therefore, the radio resources saved from a less number of measurement reports could be utilized for data traffic, thereby giving the user throughput a boost.

FIG. 3 is a flowchart of another method 300 for performing a handover in a high-speed traffic environment according to another embodiment of the present disclosure. It should be noted that the steps of the method 300 as shown may be carried out by a TD such as one of TDs 1-4 illustrated in FIG. 1.

At step S301, the method 300 receives, as a member of a group, a handover command transmitted from a source network node for the handover of the TD to a target network node, wherein the group includes a plurality of TDs and the handover command is transmitted in response to a measurement report transmitted by another member of the group to the source network node. It is to be understood that the TD herein did not transmit to the source network node a measurement report, which is generally to trigger a handover, but still receives the handover command for the handover since the other member of the group has already transmitted the measurement report to the source network node.

After that, the method 300 advances to step S302, at which the method 300 transmits, based on the handover command, a random access request to the target network node for connecting to the target network node. Although the transmission of the random access request to the target network node is discussed from one TD in the method 300, it is to be understood that each TD in the group would transmit the respective random access requests to the target network node for connecting to the target network node. In this manner, the group of TDs in the high-traffic environment may be handed over to the target network node in due course. On the one hand, the handover successful rate and handover efficiency may be improved due to this group handover in the high-speed traffic environment. On the other hand, since the group handover could be triggered merely by a single measurement report from one TD, the signaling overhead for transmitting a number of measurement reports for the group of TDs could be decreased and the saved resources in this regard could be applied for other kinds of radio traffic, thereby improving the user throughput.

In one example embodiment, the TD may be identified as a member of a group of TDs based on one or more metrics collected by the source network node or another network node, which then transmits the group information identifying each group to the source network node via, e.g., X2 interface. In another example embodiment, the one or more metrics herein may include one or more of downlink signal quality reported from the plurality of TDs, uplink signal quality determined by the source network node with respect to the plurality of TDs, Doppler frequency estimates made by the source network node with respect to the plurality of TDs, and handover history recorded by the source network node with respect to the plurality of TDs. It is to be understood that the one or more metrics herein may be of the same technical meaning as those discussed before with respect to the method 200.

Further, it is to be noted that although the method 300 is depicted and described from the TD's point of view, the corresponding steps or operations would be conducted by the counterpart, i.e., the source network node or the target network node, for performance of the group handover. For example, and as discussed above with respect to the method 200, at the source network node side, upon receipt of the measurement report from the member TD, the source network node may determine that this measurement report is transmitted from a TD in the group based on the already-stored group information and therefore a group handover procedure should be prepared for the handover of the group of TDs to the target network node. Then, the source network node may transmit the handover requests to the target network node and then receive the respective handover acknowledgement messages from the target network node. After that, the source network node may direct the group of TDs to initiate the random access procedures such that each TD may successfully connect to the target network node.

With the method 300 and its variations according to example embodiments of the present disclosure, the TDs in the high-speed traffic environment may be handed over to the target network node in a timely fashion and therefor the handover successful rate could be improved. Further, due to the high-speed traffic environment and possibly the same target network node, it is unnecessary for each TD to transmit the measurement report to the source network node to trigger the normal handover one by one, thereby lowering the signaling overhead with regards to the transmission of the redundant measurement report.

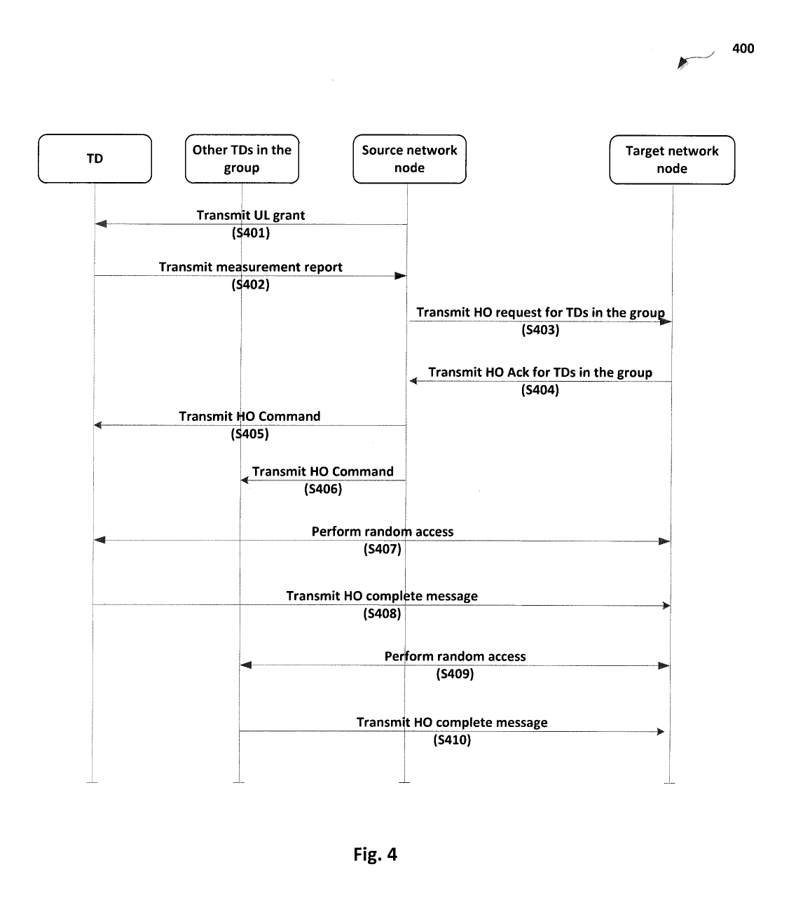

FIG. 4 is a messaging diagram schematically illustrating another method 400 of performing a handover in a high-speed traffic environment according to an embodiment of the present disclosure. It is to be understood that the operations in FIG. 4 may be a combination of the operations as performed in the methods 200 and 300 and some details may be illustrated and some additional operations may be omitted herein for brevity.

As illustrated in FIG. 4, at an initial step S401, a source network node transmits a UL grant to a TD in the high-speed traffic environment, for example, in a carriage of a high-speed train. As is known to those skilled in the art, based on the received UL grant, which may, among other things, include the resource block assignment, modulation and coding scheme, and preamble index for the potential handover procedure, the TD may perform the uplink transmission to the source network node.

At step S402, the TD transmits the measurement report to the source network node. As discussed before, the TD herein may be a member of a group of TDs in the same carriage of the high-speed train and the group of TDs have been identified as a specific group based on the one or more metrics as discussed before with respect to the methods 200 and 300.

Upon receiving the measurement report, for example, an A3 event-triggered measurement report from the TD, the source network node may ascertain that the TD is a member of the group, for example, based on the group identifier determined before the occurrence of the handover. Then, at step S403, the source network node transmits handover (“HO”) requests for all the TDs in the group to a target network node. That is, the source network node attempts to exchange handover related information with the target network node for all the TDs in the group as indicated by the group identifier.

After that and possibly within a predefined time window, the source network node receives handover acknowledgement messages from the target network node at step S404, confirming the acceptance of the group handover and reserved radio resources for the TDs' access. Upon receipt of these handover acknowledgement messages from the target network node, the source network node transmits a handover command to the TD which sent the measurement report first at step S405, and thereafter, the TD initiates and performs a random access procedure with the target network node at step S407. Meanwhile, the source network node may transmit corresponding handover commands to other TDs in the group at step S406 and thereafter, the other TDs may also initiate and perform respective random access procedures with the target network node at step S409.

Although the handover commands herein may be transmitted to the TDs one-by-one, which is compatible with the current wireless specification, in one example embodiment, the handover commands may be transmitted to the group of TDs with one signaling message, which might be used in the future system and therefore signaling overhead in this respect may be decreased.

For the TD who sent the measurement report first, after successfully connecting to the target network node, it transmits at step S408 a handover complete message to the target network node. In this case, the target network node may inform the source network node of the successful handover and therefore the source network node may release the radio resources allocated to the TD and delete pertinent user information. Similarly, at step S410, the other TDs in the group also transmit respective handover complete messages to the target network node and thereafter, the radio resources reserved for these TDs could be released and corresponding user information may be deleted by the source network node.

It is to be understood that the operations as illustrated in FIG. 4 are only for illustrative and explanatory purposes and should not be used to limit the scope of the present disclosure in any way. Further, although not illustrated in FIG. 4 for brevity, it also should be noted that the descriptions made with reference to the FIGS. 2 and 3 may also be equally applied herein, for example, the descriptions about identification of the plurality of TDs as a group according to one or more metrics.

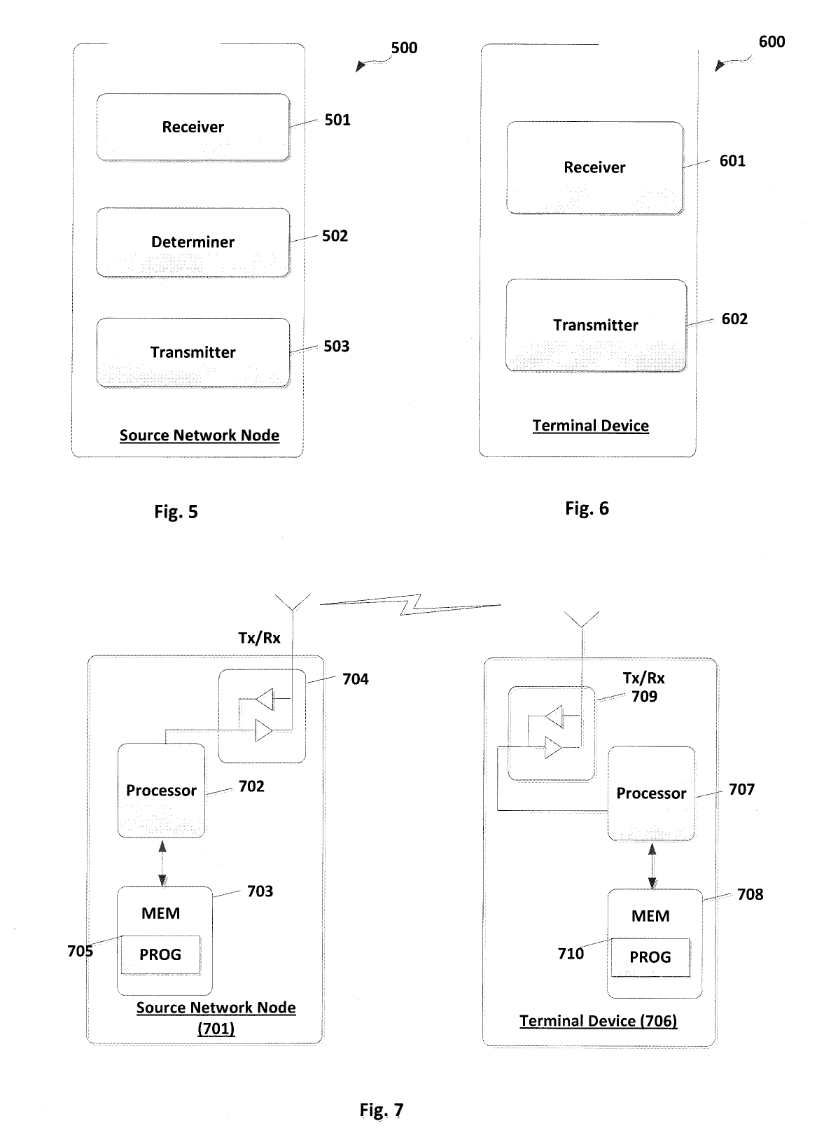

FIG. 5 is a simplified schematic block diagram illustrating a representative source network node 500 according to an embodiment of the present disclosure. As illustrated in FIG. 5, the representative source network node 500 includes a receiver 501, a determiner 502 and a transmitter 502. The receiver 501 is configured to receive a measurement report from at least one TD in the high-speed traffic environment. The determiner 502 is configured to determine whether the at least one TD is a member of a group based on group information indicating, as members of the group, a plurality of TDs. The transmitter 502 is configured to transmit, upon determining that the at least one TD is the member of the group, a plurality of handover requests each of which corresponds to one TD in the group to a target network node for the handover of each TD in the group to the target network node. In some example embodiments, the determiner 502 is further configured to determine the group information by the source network node based on one or more metrics. In other example embodiments, the receiver 501 is further configured to receive the group information from another network node that determines the group information based on one or more metrics.

From the above descriptions and those made with respect to the FIGS. 1-4, it is to be understood that the representative source network node 500 may implement the corresponding steps as discussed before in association with the methods 200-400. For example, although the receiver 501 and the transmitter 503 herein are illustrated in a separated manner, they may be combined into a single entity, such as a transceiver. Further, the determiner 502 herein may be implemented in software, hardware or some combination thereof based on different technical implementations.

FIG. 6 is a simplified schematic block diagram illustrating a representative TD 600 according to another embodiment of the present disclosure. As illustrated in FIG. 6, the representative TD 600 includes a receiver 601 and a transmitter 602. The receiver 601 is configured to receive, as a member of a group, a handover command transmitted from a source network node for the handover of the TD to a target network node, wherein the group includes a plurality of TDs and the handover command is transmitted in response to a measurement report transmitted by another member of the group to the source network node. The transmitter 602 configured to transmit, based on the handover command, a random access request to the target network node for connecting to the target network node.

From the above descriptions and those made with respect to the FIGS. 1-4, it is to be understood that the representative TD 600 may implement the corresponding steps as discussed before in association with the methods 200-400, thereby cooperating with the source network node and the target network node to complete the group handover in an efficient manner. Additionally, although the receiver 601 and the transmitter 602 herein are illustrated in a separated manner, they may be combined into a single entity, such as a transceiver.

FIG. 7 is a block diagram schematically depicting a source network node 701 (or a target network node, although not shown) and a terminal device 706 according to an embodiment of the present disclosure. As illustrated in FIG. 7, the source network node 701 includes at least one processor 702, such as a data processor, at least one memory (MEM) 703 coupled to the processor 702, and a suitable RF transmitter TX and receiver RX 704 coupled to the processor 702. The MEM 703 stores a program (PROG) 705. The TX/RX 704 is for bidirectional wireless communications, for example, it may function in a same manner as the receiver 501 and transmitter 503 as respectively illustrated in FIG. 5.

The PROG 703 is assumed to include instructions that, when executed by the processor 702, enable the source network node 701 to operate in accordance with the example embodiments of the present disclosure, as discussed herein with the methods 200-400. For example, the source network node 701 may be embodied as a serving Base Station (“BS”) or eNB, or a neighbouring or target BS or eNB, or a part thereof, to carry out the corresponding steps directed thereto as discussed in the methods 200-400.

In general, the example embodiments of the present disclosure may be implemented by computer software executable by at least one processor 702 of the source network node 701, or by hardware, or by a combination of software and hardware.

The MEM 703 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the source network node 701, there may be several physically distinct memory units in the source network node 701. The processor 702 may be of any type suitable to the local technical environment, and may include one or more of general purpose computers, special purpose computers, microprocessors, digital signal processors (DSPs) and processors based on multicore processor architecture, as non-limiting examples. The source network node 701 may have multiple processors, such as for example an application specific integrated circuit chip that is slaved in time to a clock which synchronizes the main processor.

As also illustrated in FIG. 7, the TD 706 includes at least one processor 707, such as a data processor, at least one memory (MEM) 708 coupled to the processor 707, and a suitable RF transmitter TX and receiver RX 709 coupled to the processor 707. The MEM 708 stores a program (PROG) 710. The TX/RX 709 is for bidirectional wireless communications, for example, it may function in a same manner as the receiver 601 and transmitter 602 as respectively illustrated in FIG. 6.

It is to be understood that the processor 707, the memory 708 and the program 710 stored in the memory 708 may have the same characteristics as the processor 702, the memory 703 and the program 705 in the source network node 701. For example, the TD 706 may be embodied as a UE or a part thereof to carry out the corresponding steps directed thereto as discussed in the methods 200-400. Therefore, the embodiments of the present disclosure related to the TD may be implemented by computer software executable by at least one processor 707 of the TD 706, or by hardware, or by a combination of software and hardware.

In addition, the at least one processor 702 and the memory 703 may be combined as processing means operative to perform the relevant steps as illustrated in the methods 200-400 with respect to the source network node 701. Likewise, the at least one processor 707 and the memory 708 may be combined as processing means operative to perform the relevant steps as illustrated in the methods 200-400 with respect to the TD 706.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions.

For example, the source network node according to the example embodiments of the present disclosure may include means for receiving a measurement report from at least one TD in the high-speed traffic environment. The source network node may also include means for determining whether the at least one TD is a member of a group based on group information indicating, as members of the group, a plurality of TDs. The source network node may further include means for transmitting, upon determining that the at least one TD is the member of the group, a plurality of handover requests each of which corresponds to one TD in the group to a target network node for the handover of each TD in the group to the target network node. Likewise, the TD according to example embodiment of the present disclosure may include means for receiving, as a member of a group, a handover command transmitted from a source network node for the handover of the TD to a target network node, wherein the group includes a plurality of TDs and the handover command is transmitted in response to a measurement report transmitted by another member of the group to the source network node. The TD may also include means for transmitting, based on the handover command, a random access request to the target network node for connecting to the target network node.

Many modifications and other embodiments of the disclosures set forth herein will come to mind to one skilled in the art to which these embodiments of the disclosure pertain having the benefit of the teachings presented in the foregoing descriptions and the associated drawings. Therefore, it is to be understood that the embodiments of the disclosure are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for performing a handover in a high-speed traffic environment in a source network node, comprising:
receiving a measurement report from at least one terminal device in the high-speed traffic environment;
determining whether the at least one terminal device is a member of a group based on group information indicating, as members of the group, a plurality of terminal devices; and
transmitting, upon determining that the at least one terminal device is the member of the group, a plurality of handover requests each of which corresponds to one terminal device in the group to a target network node for the handover of each terminal device in the group to the target network node.

2. The method according to claim 1, further comprising:
determining the group information by the source network node based on one or more metrics.

3. The method according to claim 1, further comprising:
receiving the group information from another network node that determines the group information based on one or more metrics.

4. The method according to claim 2, wherein the one or more metrics include one or more of the following:
downlink signal quality reported from the plurality of terminal devices;
uplink signal quality determined by the source network node or the other network node with respect to the plurality of terminal devices;
Doppler frequency estimates made by the source network node or the other network node with respect to the plurality of terminal devices; and
handover history recorded by the source network node or the other network node with respect to the plurality of terminal devices.

5. The method according to claim 2, wherein the group information is determined or received on a periodic or event-triggered basis.

6. The method according to claim 1, further comprising:
receiving a plurality of handover acknowledgement messages from the target network node; and
transmitting a handover command to each terminal device in the group via one signaling message.

7. The method according to claim 2, further comprising:
transmitting the determined or received group information to other network nodes.

8. A method for performing a handover in a high-speed traffic environment in a terminal device, comprising:
receiving, as a member of a group, a handover command transmitted from a source network node for the handover of the terminal device to a target network node, wherein the group includes a plurality of terminal devices and the handover command is transmitted in response to a measurement report transmitted by another member of the group to the source network node; and
transmitting, based on the handover command, a random access request to the target network node for connecting to the target network node.

9. The method according to claim 8, wherein the terminal device is identified as the member of the group based on one or more metrics collected by the source network node or another network node.

10. The method according to claim 9, wherein the one or more metrics include one or more of the following:
downlink signal quality reported from the plurality of terminal devices;
uplink signal quality determined by the source network node or the other network node with respect to the plurality of terminal devices;
Doppler frequency estimates made by the source network node or the other network node with respect to the plurality of terminal devices; and
handover history recorded by the source network node or the other network node with respect to the plurality of terminal devices.

11. A source network node for performing a handover in a high-speed traffic environment, comprising:
a receiver configured to receive a measurement report from at least one terminal device in the high-speed traffic environment;
a processor configured to determine whether the at least one terminal device is a member of a group based on group information indicating, as members of the group, a plurality of terminal devices; and
a transmitter configured to transmit, upon the determining that the at least one terminal device is the member of the group, a plurality of handover requests each of which corresponds to one terminal device in the group to a target network node for the handover of each terminal device in the group to the target network node.

12. The source network node according to claim 11, wherein the processor is further configured to determine the group information by the source network node based on one or more metrics.

13. The source network node according to claim 11, wherein the receiver is further configured to receive the group information from another network node that determines the group information based on one or more metrics.

14. The source network node according to claim 12, wherein the one or more metrics include one or more of the following:
downlink signal quality reported from the plurality of terminal devices;
uplink signal quality determined by the source network node or the other network node with respect to the plurality of terminal devices;
Doppler frequency estimates made by the source network node or the other network node with respect to the plurality of terminal devices; and
handover history recorded by the source network node or the other network node with respect to the plurality of terminal devices.

15. The source network node according to claim 11, wherein the group information is determined or received on a periodic or event-triggered basis.

16. The source network node according to claim 11, wherein the receiver is further configured to receive a plurality of handover acknowledgement messages from the target network node and the transmitter is further configured to transmit a handover command to each terminal device in the group via one signaling message.

17. The source network node according to claim 12, wherein the transmitter is further configured to transmit the determined or received group information to other network nodes.

18. A terminal device for performing a handover in a high-speed traffic environment, comprising:
a receiver configured to receive, as a member of a group, a handover command transmitted from a source network node for the handover of the terminal device to a target network node, wherein the group includes a plurality of terminal devices and the handover command is transmitted in response to a measurement report transmitted by another member of the group to the source network node; and
a transmitter configured to transmit, based on the handover command, a random access request to the target network node for connecting to the target network node.

19. The terminal device according to claim 18, wherein the terminal device is identified as the member of the group based on one or more metrics collected by the source network node or another network node.

20. The terminal device according to claim 19, wherein the one or more metrics include one or more of the following:
downlink signal quality reported from the plurality of terminal devices;
uplink signal quality determined by the source network node or the other network node with respect to the plurality of terminal devices;
Doppler frequency estimates made by the source network node or the other network node with respect to the plurality of terminal devices; and
handover history recorded by the source network node or the other network node with respect to the plurality of terminal devices.

21.-26. (canceled)
